(19) United States
(12) Patent Application Publication
(10) Pub. No.: US 2025/0156891 A1
(43) Pub. Date: May 15, 2025

(54) SYSTEM AND METHOD FOR INCENTIVIZING KNOWLEDGEABLE INFLUENCERS

(71) Applicant: Socialmail LLC, Palo Alto, CA (US)

(72) Inventor: Ankesh Kumar, Palo Alto, CA (US)

(21) Appl. No.: 18/413,350

(22) Filed: Jan. 16, 2024

Related U.S. Application Data
(60) Provisional application No. 63/597,873, filed on Nov. 10, 2023.

(51) Int. Cl. G06Q 30/0208; G06Q 30/04; G06Q 50/00

(52) U.S. Cl. CPC G06Q 30/0208; G06Q 30/04; G06Q 50/01

(57) ABSTRACT

The present invention is provides a system or a computer implemented for incentivizing response providers or knowledgeable influencers for providing responses to users questions. Users share their questions over a platform to get responses from response providers while providing payment for receiving the responses. In some situations, response providers are incentivized to respond to the user's questions or queries.

### FIELD OF THE INVENTION

The present invention generally relates to techniques for incentivizing content creators or Knowledgeable Influencers based on their engagement with the users. The engagement specifically includes providing responses by the content creators or Knowledgeable Influencers to the questions raised by the users.

### BACKGROUND OF THE INVENTION

Currently, content creators of the digital media are faced with many problems in monetizing their time spent on communicating with other users (people) on the social media platforms. Usually, when a person communicates with another individual (content creator) on any social platform, via email or messaging service the message ends up in an “inbox” as the content creators do not have the time to respond to all the messages and cannot monetize their time spent in responding to the messages. They obviously would prefer to spend time on revenue generating activities than just responding to the general public, which has no value for them.

The content creators may occasionally provide some responses but given lack of incentivization, there is little motivation to provide quality responses. So the number of responses are low and the quality is poor. since there is no monetary or reward to incentivize the content creators to participate and provide accurate responses.

Therefore, there is a need for a solution that enables the content creators receive monetary benefit for interacting more with the public and the public receive the benefit of quality interaction with the content creators.

### SUMMARY OF THE INVENTION

The present invention is related to a system or a method for incentivizing response providers for providing responses to users question, the method comprising: receiving a question from a user at a platform, generating a payment request to the user over the platform to receive a response for the question, submitting by the received question to a response provider intended to respond in response to a confirmation of the payment by the user, receiving a response for the received question over the platform from the response provider within a predetermined time period, transmitting the received response from the response provider to the user over the platform and providing one or more incentives to the response provider in response to the received response for the user's question.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this disclosure.

Various other objects, features, aspects, and advantages of the present invention and embodiments will become more apparent from the following detailed description of preferred embodiments, along with the accompanying drawings in which like numerals represent like components.

### BRIEF DESCRIPTION OF THE DRAWINGS

The novel features of the disclosure are set forth here. A better understanding of the features and advantages of the present disclosure will be obtained by reference to the following detailed description that sets forth illustrative embodiments, in which the principles of the disclosure are utilized, and the accompanying drawings of which:

FIG. 1 is a block diagram of participants in the interactive question and response dialog.

FIG. 2 illustrates an environment in which various user devices connecting to a social platform in graphical representation.

FIG. 3 illustrates a block diagram of a platform for question and answer processing, in accordance with an embodiment of the present invention.

FIG. 4 illustrates a flow chart that includes various steps involved in providing response to a user question, in accordance with an embodiment of the present invention.

FIG. 5 illustrates a question and response system, in accordance with an embodiment of the present invention.

### DETAILED DESCRIPTION OF THE INVENTION

In the following description, numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

In one embodiment, the platform is designed to enable users or individuals or viewers to communicate with online influencers or content creators or response providers or Knowledgeable Influencers for a fee, which is determined by the response provider. The platform connects people or users with response providers across various fields including but not limited to travel, beauty, health or car repairs etc. The platform offers a range of features but not limited to creating influencer profiles, message functionality, payment processing, chatbot integration, ratings/reviews, reporting or a design studio etc.

In an embodiment, where a person who is a questioner has a need for an answer from another person can pay to have their question answered. The main advantage is that the person answering (i.e. response provider) the question has stipulated what they need financially (i.e. monetary benefit) to respond, they are more likely to provide a response. Hence both parties get what they need, the questioner gets an answer and the person responding gets the monetary benefit.

In another embodiment, the monetary benefit includes but not limited to traditional currency, crypto currency or NFT etc.

In another embodiment, response providers can be but not limited to Knowledgeable Influencers or online influencers or content creators or advertisers or marketing agencies or companies or businesses etc. and the users can be but not limited to individuals, followers, fans or common people etc.

In another embodiment, online influencers create profiles on the platform, where they provide their contact information and set their preferred fee for providing responses to the questions raised by the users. These profiles serve as a central hub for their online presence.

In another embodiment, the platform can be but not limited to a website, a mobile application or a standalone software associated with a company or an advertiser etc.

In one embodiment, the platform also works with Intermediaries. For example but not limited to marketing agencies that represent “Knowledgeable Influences”. Since, they handle the business affairs of those individuals (response providers or knowledgeable influencers), they would be in the process. There would be a revenue share between the platform and the intermediaries, which would be flexible and negotiable.

In another embodiment, the questions and responses can be in the form of text, voice, video, image or any other media formats.

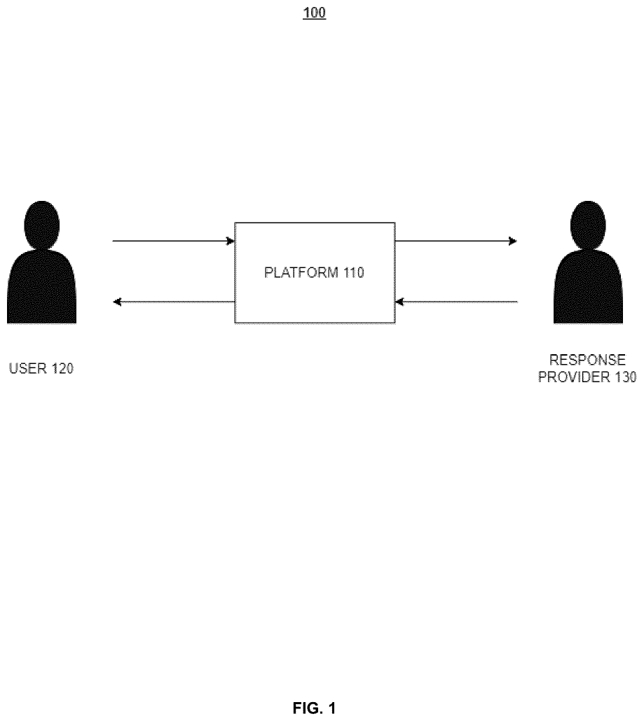

FIG. 1 shows a block diagram of participants in the interactive question and response dialog 100. The user 120 interacts and communicates with the response provider 130 over the platform 110.

In one embodiment the user 120 and the response provider 130 communicate over the platform using computing devices including but not limited to a laptop, tablet or desktop personal computer, a mobile telephone, or another type of computer or processing device.

The platforms 110 can be a social media platform where user data and response provider data is linked and the platform 110 access one or more social media accounts linked to the social media platforms by obtaining credentials from the user 120 and the response provider 130.

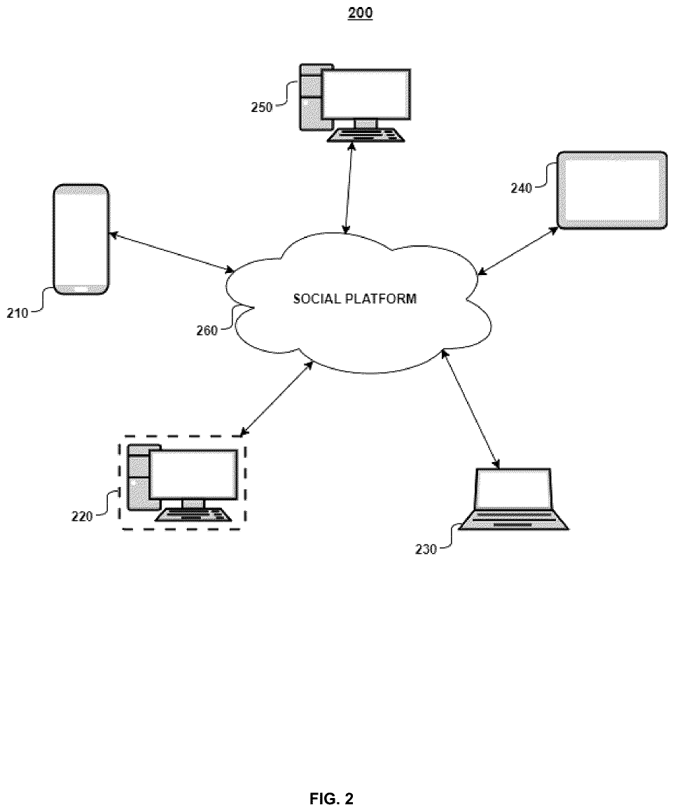

FIG. 2, illustrates an environment 200 in which various user devices connecting to the social platform 260 to run on them.

In some embodiments, the user devices can include but not limited to a mobile phone 210, a virtual computer 220, a laptop 230, a tablet 240, a computer 250.

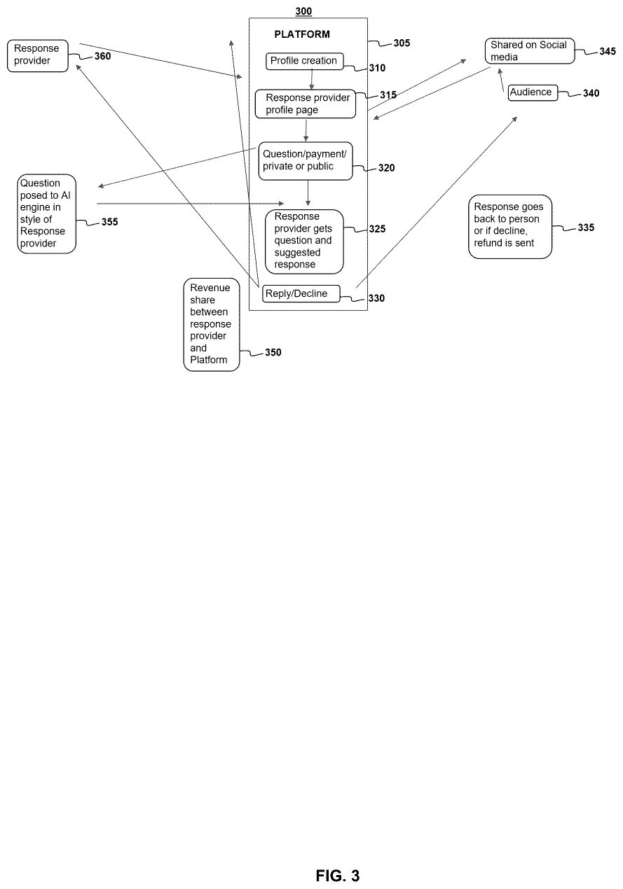

FIG. 3, illustrates a platform 305 of the system 300 for question and answer processing between users or audience 340 and response providers 360. The response provider 360 create profile 310 on the platform 305 and a response provider profile page 315 is generated. Audience 340 raise their questions on the platform 305 intended for specific response provider 360 and makes payment over the platform in order to receive a response. The platform 304 provides the user to select an option whether to make the conversation private or public. The response provider 360 is provided with an option of reply or decline 330 over the platform and receives the question to be responded if reply is selected. Also, the response provider is presented with an option of Artificial Intelligence assistance 355 wherein, the AI engine receives the user's question and generates a response in the style of the response provider. The AI engine is trained according to the style of responding of the response provider. The AI engine generated response is provided to the response provider for review before sending to the user or audience 340. Further, if the response provider declines to respond the payment made will be refunded to the user or audience 340. In case the audience selects the conversation to be public then the platform 305 provides and option to share the conversation on social media. Further, the payment made by the audience 340 is shared between the platform 305 and the response provider 360.

In some embodiments, response providers may be compensated and otherwise incentivized for interacting with the users over the platform in various ways. For example, response providers who provide responses to questions raised by the users may be rewarded in a manner specific to the question and their response(s), such as to split a total amount of monetary reward for the question between the response provider and the platform. In addition, a portion of an ongoing revenue stream that is later generated from or otherwise associated with the answer may be shared with the response provider who provided the responses.

In one embodiment, the platform allows response providers to easily locate and/or access previously-answered questions and to assist in tracking the same. The responses may also get tagged with user's unique id and are categorized so as to help response providers know from whom the questions are received and what responses are sent.

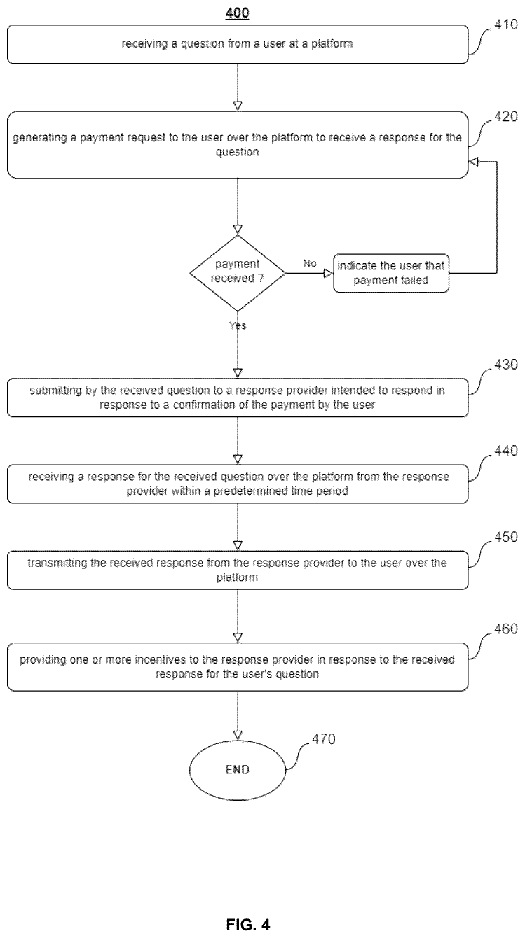

FIG. 4. Illustrates various steps performed within the method for incentivizing response providers for providing responses to users question 400 according to an embodiment of the present invention.

The steps includes:
Step 410: receiving a question from a user at a platform;
Step 420: generating a payment request to the user over the platform to receive a response for the question;
Step 430: submitting by the received question to a response provider intended to respond in response to a confirmation of the payment by the user;
Step 440: receiving a response for the received question over the platform from the response provider within a predetermined time period;
Step 450: transmitting the received response from the response provider to the user over the platform; and
Step 460: providing one or more incentives to the response provider in response to the received response for the user's question.
Step 470: End of the conversation.

In one embodiment, the monetary reward includes but not limited to cryptocurrency, fiat currency, cryptocurrency, coupons, gift cards or tokens.

In some embodiments, the platform can be but not limited to a mobile extension, mobile application, desktop application, software, or a plugin.

In some embodiments, the platform has an SDK so that other developers, applications and platforms can integrate and tweak the application to their fitting (plug and play).

In one embodiment, smart contracts for e.g. digital agreements are created between the platform and the response providers which helps the response providers in obtaining revenue share from the platform. The revenue share can be modified and amended depending on market conditions and needs.

In some embodiments, the system or method can utilize Artificial Intelligence (AI) to generate responses in the style of response provider.

In some embodiments, the platform provides privacy and security like but not limited to advanced encryption standards, secure multi-party computation, differential privacy, or homomorphic encryption in order to access.

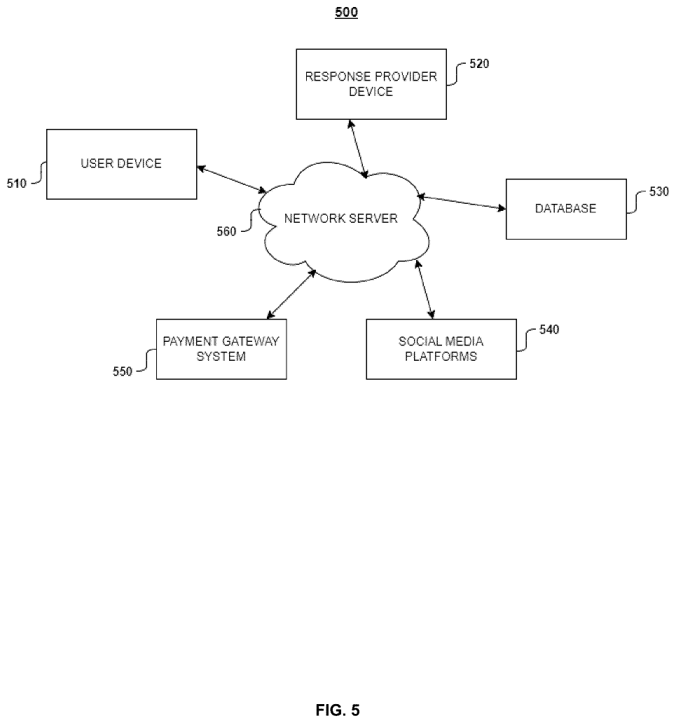

FIG. 5 shows a question and response system 500, where the user device 510, the response provider device 520, a database 530, social media platform 540 and payment gateway system 550 are connected to a network server 560. Database 530 stores all the transactions, log records, communication etc. performed between various entities.

The payment gateway system 550 in the one embodiment is assumed to be associated with a financial institution such as a bank or other issuer of credit cards, debit cards or other types of payment cards or more generally payment mechanisms. Examples of payment mechanisms other than payment cards that can be utilized in illustrative embodiments include checks or other similar financial instruments. More particularly, in the case of a check or other similar financial instrument, an image of the check or financial instrument could be used in combination with evidence of user identity. Illustrative embodiments of secure cryptocurrency purchase functionality disclosed herein are generally utilizable with any form of financial instrument for which there is a need to verify the identity of the user.

In some embodiments, the user device and the response provider devices receives inputs from user interface displayed to the user and the response provider.

In some embodiments, the plat form provides Message Functionality where, users can access the messaging functionality from response provider's or influencer's blogs, social media profiles or the platform itself. Users submit questions and are prompted to pay a fee to get their questions answered.

The platform further provides Influencer Acceptance where once a question is submitted, the influencer is notified and has the option to accept or decline the question. If the influencer declines, the user is refunded the full amount.

In another embodiment, the influencer has a predefined time frame (for example but not limited to 1 hour, 24 hours, 72 hours or 1 week) set by the platform to respond to a question and if they do not respond within that time frame a refund is made to the user or viewer or person who asked the question. Once the Influencer has responded, the user or person has the option to ask as many follow-up questions as they chose for a fee.

In another embodiment, the knowledgeable Influencer or response provider is allowed to set their preferred time to respond to the user's questions and the same is communicated to the user or person asking the question.

In another embodiment, the platform can also allow the response provider to limit the number of questions they want to receive over a time period they select For example but not limited to no more than 10 questions in a 24 hour period and the questions following would be either rejected or kept in a queue for responding later. The person responding to the questions can also modify their price or fee at any time upwards or downwards to modulate the number of questions they receive.

In another embodiment, the knowledgeable influencer can choose to make their response private and request a fee if another user or viewer of their page would like to uncover their response to a question previously asked.

In one embodiment, the method for incentivizing respond providers for providing response to the users questions comprises steps of: The method of claim 1 wherein, the method further comprises:
a. providing the received user question to a chatbot service;
b. receiving a generic response from the chatbot service for the received user question;
c. passing the generic response to a large language model, wherein the large language model is trained on data or information of the intended response provider;
d. generating a personalized response aligned with style or format or tone or manner of the intended response provider; and
e. providing the intended response provider, the generated personalized response for review.

In some embodiments, the platform is integrated with Chatbot Integration: Simultaneously, the platform uses chatbots, such as ChatGPT, Bard/Google, etc., to provide answers to the influencer, assisting them in responding to user questions using external sources.

In another embodiment, the answer generated by generic chatbots can then be passed onto a LLM, Large Language Model for obtaining response provider style responses.

In another embodiment, the platform provides Ratings/Reviews: it includes a ratings and reviews system to encourage high-quality responses from influencers and to provide valuable feedback to users.

The platform further includes:
Reporting system: The platform features sophisticated metric analysis tools that offer insights into user engagement, influencer performance, and other relevant data to enhance the user experience.
Design Studio: Influencers can use a design studio to brand themselves visually to their online audience. This includes the ability to add visually appealing elements, pictures, and customize text/images/colors.
Viral Features: The platform encourages other influencers to join by showcasing its functionality, creating a viral effect within the influencer community.

In another embodiment, the user question submitted can be chosen to be private or public by the user submitting the question. If the question is public the response provider responding has the option to share that question on their social media sites. Allowing other people who may have the same question as well as gauging the quality of responses.

In another embodiment, the platform interacts with multiple response providers to generate revenue and store details about the revenue generated. Revenue details may be stored in the database 530. In those embodiments that determine or estimate the revenue generated for each question, the platform may also keep track of the revenue generated for the question.

In one embodiment, the user is notified by the platform when the response provider provides response for the question raised by the user. The notification can be but not limited to SMS, an alert, an email or a push notification.

In some embodiments, the user can anonymously raise a question and the response provider can anonymously provide response to the user question while maintaining privacy.

In another embodiment, the user question is linked with a tag to identify the intended response provider from a plurality of response providers and the received question is assigned to the intended response provider.

In some embodiments, the response provider can be but not limited to an individual, a content creator or a knowledgeable influencer.

In some embodiments, a company or a service provider or an advertiser can engage with the response providers for marketing or recommending their products or services when interacting with the users. They can also make payment to the response provides for responding to the users questions without asking the users for the payment.

In some embodiments, the platform includes a Graphical User Interface (GUI) that is interactive for the users and the response providers for easy interaction between them.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules or logical components referred to herein may, in some example embodiments, comprise processor-implemented modules or logic.

The system explained herein can be a computer system and the computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units, system memory, and bus that couples various system components including system memory to processor. Processor may include software module that performs the methods described herein. The module may be programmed into the integrated circuits of processor, or loaded from memory, storage device, or network or combinations thereof.

Bus may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus. Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hard-wired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

System memory can include computer system readable media in the form of volatile memory, such as random access memory (RAM) and/or cache memory or others. Computer system may further include other removable/non-removable volatile/non-volatile computer system storage media. By way of example only, storage device can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus by one or more data media interfaces.

Computer system may also communicate with one or more external devices such as a keyboard, a pointing device, a display, etc; one or more devices that enable a user to interact with computer system; and/or any devices (e.g., network card, modem, etc.) that enable computer system to communicate with one or more other computing devices. Such communication can occur via Input/Output (I/O) interfaces.

Computer system can communicate with one or more networks such as a local area network (LAN), a general wide area network (WAN), and/or a public network (e.g., the Internet) via network adapter. As depicted, network adapter communicates with the other components of computer system via bus. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Aspects of the present disclosure are described with reference to flowchart illustrations and/or block diagrams of methods, apparatus (systems) and computer program products according to some embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The above description illustrates various embodiments of the present disclosure along with examples of how aspects of these embodiments may be implemented. The above examples and embodiments should not be deemed to be the only embodiments, and are presented to illustrate the flexibility and advantages of the present disclosure as defined by the following claims. For example, although certain embodiments have been described with respect to particular process flows and steps, it should be apparent to those skilled in the art that the scope of the present disclosure is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the present disclosure as set forth in the following claims.

The present invention may be embodied in other specific forms without departing from its spirit or essential characteristics. The described embodiments are to be considered in all respects only as illustrative and not restrictive. The scope of the invention is, therefore, indicated by appended claims rather than by the foregoing description. All changes which come within the meaning and range of equivalency of the claims are to be embraced within their scope.

I/We claim:

1. A computer-implemented method for incentivizing response providers for providing responses/answers to user's questions, the method comprising:
a. discovering and selecting by a user over a platform, a response provider from a plurality of response providers;
b. submitting by the user over the platform a question to the selected response provider;
c. generating a payment request to the user over the platform to receive a response for the question;
d. submitting by the platform, the received question to the response provider intended to respond in response to a confirmation of the payment from the user;
e. receiving a response for the received question over the platform from the response provider within a predetermined time period;
f. transmitting the received response from the response provider to the user over the platform; and
g. providing one or more incentives to the response provider in response to the received response for the user's question.

2. The method of claim 1 wherein, the selected response provider is provided with a suggested response by the platform from an Artificial Intelligence (AI) engine, that can assist in crafting a response.

3. The method of claim 1 wherein, the received response is transmitted to the user over the platform and/or to the user preferred means for e.g. but not limited to email or any social platform etc.

4. The method of claim 1 wherein, the payment is made by the user communicating to the response provider, on any messaging platforms, email, direct messaging or any other form of communication and the submission of the question for a fee may or may not require a response from the response provider the question has been submitted to.

5. The method of claim 1 wherein, the question is linked with a tag to identify the intended response provider from the plurality of response providers and the received question is assigned to the intended response provider.

6. The method of claim 1 wherein, the payment is reversed to the user when the response is not received from the response provider within the predetermined time period.

7. The method of claim 1 wherein, the response provider is notified when the platform receives a question intended to respond by the response provider.

8. The method of claim 1 wherein, the question and the response can be but not limited to simple text, voice, video or any other media formats.

9. The method of claim 1 wherein, the platform can be but not limited to a website, a software application or a webpage or any social media platform.

10. The method of claim 1 wherein, the response provider is provided with an option to accept or decline the question over the platform.

11. The method of claim 1 wherein, the method further comprises:
a. providing the received user question to an Artificial Intelligence (AI) service;
b. receiving a response from the AI service for the received user question;
c. passing the response to a large language model, wherein the large language model is trained on data or information of the intended response provider;
d. generating a personalized response aligned with style or format or tone or manner of the intended response provider; and
e. providing the intended response provider, the generated personalized response for review.

12. The method of claim 1 wherein, the user is provided an option by the platform on whether to make the user question private or public in order to maintain privacy.

13. The method of claim 1 wherein, the response provider can be but not limited to an individual, a content creator or a knowledgeable influencer.

14. The method of claim 1 wherein, the payment received from the user is shared between the platform and the response provider.

15. The method of claim 1 wherein, the platform provides an option to limit the number of questions the responder provider want to receive for a specific time period.

16. The method of claim 1 wherein, the response provider can assign and modify price for the questions at any time upwards or downwards to modulate the number of questions they receive.

17. The method of claim 1 wherein, an intermediary entity can handle business of the response provider and the platform can share the payment with the intermediary entity.

18. The method of claim 1 wherein, the intermediary entity can be but not limited to a company, a marketing agency or a business etc.

19. The method of claim 1 wherein, the response provider is provided an option by the platform to choose to make the response private and request a payment or fee if another user or viewer of their page would like to access the response to the question previously asked.
